(19) United States
(12) Patent Application Publication
(10) Pub. No.: US 2022/0145029 A1
(43) Pub. Date: May 12, 2022

(54) TRANSPARENT HYDROPHILIC ULTRAVIOLET-ABSORBING LAMINATE AND COATING AGENT

(71) Applicant: 3M INNOVATIVE PROPERTIES COMPANY, St. Paul, MN (US)

(72) Inventors: Naota Sugiyama, Kanagawa (JP); Taiki Ihara, Tokyo (JP)

(21) Appl. No.: 17/593,358

(22) PCT Filed: Mar. 20, 2020
(86) PCT No.: PCT/IB2020/052620

§ 371 Date: Sep. 16, 2021

(30) Foreign Application Priority Data
Apr. 1, 2019 (JP) 2019-070154

(51) Int. Cl. C08J 7/056; C08J 7/043; C08J 7/04; C08K 3/22; C08K 3/36

(52) U.S. Cl. CPC C08J 7/056; C08J 7/043; C08J 7/042; C08K 3/22; C08K 2201/005; C08J 2433/14; C08K 2003/2227; C08K 2003/2296; C08K 3/36

(57) ABSTRACT

A transparent hydrophilic ultraviolet-absorbing laminate and a transparent hydrophilic ultraviolet-absorbing coating agent, having excellent transparency, hydrophilicity, and ultraviolet-shielding properties are provided. The transparent hydrophilic ultraviolet-absorbing laminate according to an aspect of the present embodiment includes: a substrate; and a transparent hydrophilic ultraviolet-absorbing layer containing first inorganic nanoparticles, second inorganic nanoparticles, and a hydrophilic binder, and exhibiting a water contact angle of 30.0 degrees or less; wherein the second inorganic nanoparticles are core-shell ultraviolet-absorbing particles different from the first inorganic nanoparticles, and the shell contains silicon oxide.

### TECHNICAL FIELD

The present disclosure relates to a transparent hydrophilic ultraviolet-absorbing laminate and coating agent.

### BACKGROUND

A technique to apply a hydrophilic coating layer or an ultraviolet-absorbing coating layer to a substrate to exhibit hydrophilicity or ultraviolet-shielding performance has been known in the art.

Patent Document 1 (JP 2018-180099 A) describes a hydrophilic hard coat laminate including a substrate and a hydrophilic hard coat laminate, the hydrophilic hard coat layer having an initial water contact angle of 20 degrees or less, the hydrophilic hard coat laminate containing a hydrophilic binder and 60 mass % or greater of inorganic nanoparticles based on the total weight of the hydrophilic hard coat layer, the inorganic nanoparticles being dispersed in the hydrophilic binder.

Patent Document 2 (WO 2009/044912) describes a hydrophilic substrate formed by using a hydrophilic coating agent containing a colloidal silica sol (A), an acrylic polymer (B) including active hydrogen and having a weight average molecular weight (Mw) of 5000 to 200000, a reactive silane coupling agent (C), and a curing agent (D) for the acrylic polymer (B), wherein the mass ratio of the component (A) to the component (B) [(A)/(B)] is from 5/95 to 95/5, and the mass ratio of the total of the component (A) and the component (B) to the component (C) [(A+B)/(C)] is from 30/70 to 95/5.

Patent Document 3 (WO 2018/052686) describes an ultraviolet-absorbing hard coat including a hydrophobic binder and ZnO nanoparticles, wherein the ZnO nanoparticles are contained in a range from 1 to 90 mass % based on the total weight of the hard coat, at least a portion of the nanoparticles are surface-modified with L-lysine and include a silica coating on the surface modification, and the silica coating is surface-treated with a silane coupling agent.

### SUMMARY OF INVENTION

### Technical Problem

To allow the hydrophilic coating layer to exhibit ultraviolet absorption ability, an organic ultraviolet absorber is typically used. However, organic ultraviolet absorbers are hydrophobic, and thus an organic ultraviolet absorber used in combination with a hydrophilic binder or hydrophilic monomer could reduce the performance of the hydrophilic coating layer (e.g., transparency and hydrophilicity).

For example, as described in Examples of Patent Document 3, a technique related to a coating agent containing a hydrophobic binder or a hydrophobic monomer is completely opposite to a technique related to a hydrophilic coating agent, and thus not applying such a technique to a hydrophilic coating agent is a technical common sense at the time of patent filing. Such a hydrophobic technique, in a case where applied to a hydrophilic coating agent, could reduce the performance of the hydrophilic coating layer (e.g., transparency and hydrophilicity).

In the field related to hydrophilic coating agents, there has been so far no technique satisfying all performances of transparency, hydrophilicity, and ultraviolet-shielding properties, and a coating agent exhibiting such performances and a laminate formed from the coating agent have been desired.

### Solution to Problem

The present disclosure provides a transparent hydrophilic ultraviolet-absorbing laminate and a transparent hydrophilic ultraviolet-absorbing coating agent, having excellent transparency, hydrophilicity, and ultraviolet-shielding properties.

An embodiment of the present disclosure provides a transparent hydrophilic ultraviolet-absorbing laminate including: a substrate; and a transparent hydrophilic ultraviolet-absorbing layer containing first inorganic nanoparticles, second inorganic nanoparticles, and a hydrophilic binder, and exhibiting a water contact angle of 30.0 degrees or less; wherein the second inorganic nanoparticles are core-shell ultraviolet-absorbing particles different from the first inorganic nanoparticles, and the shell contains silicon oxide.

Another embodiment of the present disclosure provides a transparent hydrophilic ultraviolet-absorbing coating agent containing first inorganic nanoparticles, second inorganic nanoparticles, and at least one selected from a hydrophilic binder, a hydrophilic curable monomer, and a hydrophilic curable oligomer, wherein the second inorganic nanoparticles are core-shell ultraviolet-absorbing particles different from the first inorganic nanoparticles, and the shell contains silicon oxide; and a transparent hydrophilic ultraviolet-absorbing layer formed by the coating agent exhibits a water contact angle of 30.0 degrees or less.

### Advantageous Effects of Invention

The present disclosure can provide a transparent hydrophilic ultraviolet-absorbing laminate and a transparent hydrophilic ultraviolet-absorbing coating agent, having excellent transparency, hydrophilicity, and ultraviolet-shielding properties.

The above descriptions should not be construed as that all aspects of the present embodiment and all advantages of the present disclosure are disclosed.

### BRIEF DESCRIPTION OF DRAWINGS

FIG. 1 is a graph related to ultraviolet-shielding properties in configurations of Example 6 to Example 11 and Comparative Example 1.

### DESCRIPTION OF EMBODIMENTS

Hereinafter, the present invention will be described in more detail to exemplify representative embodiments of the present invention, but the present invention is not limited to these embodiments.

In the present disclosure, “(meth)acrylic” means acrylic or methacrylic, and “(meth)acrylate” means acrylate or methacrylate.

In the present disclosure, “hydrophilic” means having a lower water contact angle than a substrate, or a performance that can exhibit water dispersibility or water solubility.

In the present disclosure, “transparent” refers to a light transmittance in the visible light region (wavelength from 400 to 700 nm) of 80.0% or higher, and the light transmittance may be desirably 85.0% or higher, 87.0% or higher, or 90.0% or higher. The upper limit value of the light transmittance is not limited to a particular value but can be, for example, lower than 100%, 99.0% or lower, or 98.0% or lower. Alternatively, in the present disclosure, “transparent” may refer to a haze of 5.0% or lower, desirably 4.0% or lower, or 3.0% or lower. The lower limit value of the haze is not particularly limited but can be, for example, 0.5% or higher, 0.7% or higher, or 1.0% or higher.

In the present disclosure, “ultraviolet” means a region having a wavelength of less than 400 nm, 380 nm or less, 360 nm or less, or 350 nm or less, and 200 nm or greater.

In the present disclosure, “dispersed” means being not aggregated, and “water-dispersible” means a state in which inorganic nanoparticles are not aggregated and not precipitated in water.

In the present disclosure, “on” for example, as in “a transparent hydrophilic ultraviolet-absorbing layer disposed on a substrate” means that the transparent hydrophilic ultraviolet-absorbing layer is disposed directly on the substrate or that the transparent hydrophilic ultraviolet-absorbing layer is disposed indirectly over the substrate via a different layer.

According to one embodiment, a transparent hydrophilic ultraviolet-absorbing laminate includes: a substrate; and a transparent hydrophilic ultraviolet-absorbing layer containing first inorganic nanoparticles, second inorganic nanoparticles, and a hydrophilic binder, and exhibiting a water contact angle of 30.0 degrees or less; in which the second inorganic nanoparticles are core-shell ultraviolet-absorbing particles different from the first inorganic nanoparticles, and the shell contains silicon oxide.

The material of the substrate is not particularly limited, and, for example, an organic material, an inorganic material, and a metal material can be used. Examples of the organic material may include polycarbonates, poly(meth)acrylates (e.g., polymethylmethacrylates (PMMA)), polyolefins (e.g., polyethylenes (PE) and polypropylenes (PP)), polyurethanes, polyesters (e.g., polyethylene terephthalates (PET) and polyethylene naphthalates (PEN)), polyamides, polyimides, phenolic resins, cellulose diacetates, cellulose triacetates, polystyrenes, styrene-acrylonitrile copolymers, acrylonitrile-butadiene-styrene copolymers (ABS), epoxies, polyacetates, and vinyl chloride. Examples of the inorganic material may include glass and ceramics, and examples of the metal material may include aluminum, iron, copper, and alloys of these metals (e.g., stainless). These metals can be used alone or in combination of two or more.

The shape or configuration of the substrate is not particularly limited and may be, for example, a film shape, a plate shape, a curved surface shape, an odd shape, or a three-dimensional shape, or may be a single-layer configuration, a laminate configuration, or a composite configuration, such as those formed of a combination of a plurality of substrates having different shapes.

The substrate may be transparent or colored and transparent. In the present disclosure, “colored and transparent” is intended for transparency that enables an object to be visually recognized via a colored substrate, for example sunglasses, and in this case, the light transmittance in the visible light region may be 80.0% or lower. The light transmittance in the visible light region in the present disclosure means an average transmittance in the region of wavelength from 400 nm to 700 nm measured at 25° C. using a spectrophotometer in accordance with JIS K 7361-1 (1997).

The thickness of the substrate is not particularly limited, and, for example, the thickness of a film substrate can be 5 micrometers or greater, 10 micrometers or greater, or 15 micrometers or greater, and can be less than 500 micrometers, 400 micrometers or less, or 300 micrometers or less. The thickness of a substrate thicker than the film substrate, for example, a plate substrate, can be 0.5 mm or greater, 1 mm or greater, or 1.5 mm or greater, and can be 10 mm or less, 7 mm or less, or 5 mm or less.

The transparent hydrophilic ultraviolet-absorbing layer of the present disclosure has hydrophilic performance. Hydrophilic performance can be defined by a water contact angle. For example, the water contact angle of such a layer surface can be 30.0 degrees or less, 25.0 degrees or less, 20.0 degrees or less, or 15.0 degrees or less. The lower limit value of the water contact angle is not particularly limited but can be, for example, 1.0 degree or greater, 2.0 degrees or greater, or 3.0 degrees or greater.

The hydrophilic binder is not particularly limited, and examples of the hydrophilic binder may include polyethylene glycol; poly-N-vinylpyrrolidone; polyvinyl acetate; hydrophilic poly(meth)acrylates, for example, (meth)acrylic resins including at least one selected from an amphoteric ion, ethylene oxide, and propylene oxide; hydrophilic polyurethanes; and resins including a hydroxyl group. These binders can be used alone or in combination of a plurality of them. Such hydrophilic binders can be prepared using a hydrophilic curable monomer and/or a hydrophilic curable oligomer and have excellent water dispersibility or water solubility. For example, from the perspectives, such as exhibiting hydrophilicity and weather resistance, the binder having hydrophilicity is preferably free of an aromatic group. Here, in the present disclosure, when simply referred to as “curable”, such “curable” includes performance of curing, such as thermal curing and ionizing radiation curing, and the curing performance can be appropriately selected according to such as the use and the productivity. In addition, curing in the present disclosure also includes what is commonly referred to as polymerization.

The hydrophilic binder can improve hydrophilicity, scratch resistance, and/or adhesion to a substrate or a surface treatment layer (e.g., a primer layer) in the transparent hydrophilic ultraviolet-absorbing layer. In view of such performance, the following is preferably used as the hydrophilic binder: at least one selected from polyethylene glycol, a resin including a hydroxyl group, and a (meth)acrylic resin including at least one selected from an amphoteric ion, ethylene oxide, and propylene oxide. Examples of the resin including a hydroxyl group that can be used include a hydroxyl group-containing (meth)acrylic resin and a hydroxyl group-containing polyester resin obtained from a curable (meth)acrylic monomer or oligomer.

Among them, from the perspective of hydrophilicity, scratch resistance, and dispersion stability of the first and second inorganic nanoparticles described below, the hydrophilic binder is preferably a (meth)acrylic resin including at least one selected from ethylene oxide and propylene oxide. Such a (meth)acrylic resin can be obtained by polymerization of a hydrophilic monomer, for example, polyethylene glycol (meth)acrylate, polyethylene glycol di(meth)acrylate, polyethylene glycol tri(meth)acrylate, polypropylene glycol (meth)acrylate, polypropylene glycol di(meth)acrylate, and polypropylene glycol tri(meth)acrylate. These hydrophilic monomers can be used alone or in combination of two or more. Various monomers differing in ethylene or propylene glycol chain length can be used for such polyethylene glycol (meth)acrylates or polypropylene glycol (meth)acrylates, and the hydrophilicity can be controlled by the chain length, that is, the number (n) of the ethylene or propylene glycol unit per chain. For example, for a binder having hydrophilicity, a monomer having a chain length of 1 or greater can be used, and a monomer having a chain length of 5 or greater, 7 or greater, or 10 or greater can be preferably used. A monomer having too long chain length would whiten the coating agent, and thus the upper limit of the chain length can be 500 or less.

Any (meth)acrylic resin above that is hydrophilic can be obtained using one or a plurality of well-known curable monofunctional monomers, polyfunctional monomers, or oligomers having or not having hydrophilicity in combination together with, for example, one or more polyfunctional monomers, among the above hydrophilic monomers, polyethylene glycol di(meth)acrylate, polyethylene glycol tri(meth)acrylate, polypropylene glycol di(meth)acrylate, and polypropylene glycol tri(meth)acrylate.

A monomer including one ethylenic double bond can be used as the monofunctional monomer. Examples of such monofunctional monomers that can be used include, but are not limited to, 2-hydroxyethyl acrylate (HEA), 2-hydroxypropyl acrylate (HPA), 2-hydroxyethyl methacrylate (HEMA), a styrene monomer, ethyl acrylate, and butyl acrylate.

As the polyfunctional monomer or oligomer, curable polyfunctional monomers or oligomers including a bifunctional or higher reactive functional group can be used. Examples of the curable polyfunctional monomers or oligomers may include polyfunctional (meth)acrylate monomers, polyfunctional (meth)acrylic urethane monomers, and oligomers of these monomers.

The polyfunctional (meth)acrylate monomer or oligomer is an organic compound including two or more (meth)acryloyloxy groups per molecule. Examples of the polyfunctional (meth)acrylate monomer or oligomer that can be used include, but are not limited to, tricyclodecanedimethylol diacrylate, polypropylene glycol diacrylate, polyethylene glycol diacrylate, trimethylolpropane triacrylate, trimethylolpropane trimethacrylate, trimethylolpropane PO-modified triacrylate, glycerin PO-added triacrylate, ε-caprolactone-modified tris(acloxyethyl)isocyanurate, pentaerythritol triacrylate, pentaerythritol tetraacrylate, ditrimethylolpropane tetraacrylate, dipentaerythritol pentaacrylate, dipentaerythritol hexaacrylate, dendrimer acrylate, or oligomers of these monomers.

The polyfunctional (meth)acrylate urethane monomer or oligomer is an organic compound including two or more (meth)acryloyloxy groups per molecule. Examples of the polyfunctional (meth)acrylic urethane monomer or oligomer that can be used include, but are not limited to, a phenyl glycidyl ether acrylate hexamethylene diisocyanate urethane prepolymer, a pentaerythritol triacrylate toluene diisocyanate urethane prepolymer, a dipentaerythritol pentaacrylate hexamethylene diisocyanate urethane prepolymer, or oligomers of these monomers.

In using a hydrophilic polyfunctional monomer or oligomer, a non-hydrophilic polyfunctional monomer or oligomer, a hydrophilic monofunctional monomer, and a non-hydrophilic monofunctional monomer in combination, these monomers or oligomers can be used by appropriately mixing in view of hydrophilicity, scratch resistance, and the like.

The polymerization of the monomer or the oligomer is not limited to the following but can be carried out, for example, by thermal polymerization or photopolymerization. In the thermal polymerization, a thermal polymerization initiator can be used. Examples of the thermal polymerization initiator that can be used include, but are not limited to, hydrophilic thermal polymerization initiators, such as peroxides (e.g., potassium peroxodisulfide and ammonium peroxodisulfide) and azo compounds (e.g., VA-044, V-50, V-501, VA-057 (available from Wako Pure Chemical Industries, Ltd.). Additionally, a radical initiator including a polyethylene oxide chain can also be used. A tertiary amine compound, such as N,N,N′,N′-tetramethylethylenediamine and β-dimethylaminopropionitrile, can be used as a catalyst.

Photopolymerization can be carried out using ionizing radiation, such as, for example, an electron beam and ultraviolet light. In using an electron beam, a photopolymerization initiator may not be used, but in photopolymerization using ultraviolet light, a photopolymerization initiator is used. Examples of the photopolymerization initiator that can be used include a water-soluble or hydrophilic photopolymerization initiator, including, but not limited to IRGACURE 2959, DAROCUR 1173, DAROCUR 1116, and IRGACURE 184 (available from BASF Corporation); and CANTACURE ABQ, CANTACURE BT, and CANTACURE QTX (available from Shell Chemicals Japan).

The total amount of the hydrophilic binder included in the transparent hydrophilic ultraviolet-absorbing layer or the total amount of at least one selected from the hydrophilic binder, the hydrophilic curable monomer, and the hydrophilic curable oligomer included in the transparent hydrophilic ultraviolet-absorbing coating agent can be 5 mass % or greater, 10 mass % or greater, 15 mass % or greater, and can be 30 mass % or less, 25 mass % or less, 23 mass % or less, or 20 mass % or less, based on the total weight (dry coating amount) of the transparent hydrophilic ultraviolet-absorbing layer or the total weight (solid content) of the transparent hydrophilic ultraviolet-absorbing coating agent.

Note that when the silane coupling agent described below is hydrophilic and is a silane coupling agent including a vinyl group, or a (meth)acryl group, such a silane coupling agent can be considered as one of the hydrophilic binders.

The first inorganic nanoparticles are not particularly limited, and any inorganic nanoparticle allowing the transparent hydrophilic ultraviolet-absorbing layer to exhibit a predetermined water contact angle can be used, for example, at least one particles selected from silica (SiO, SiO₂), alumina (Al₂O₃), zirconium oxide (ZrO₂), tin-doped indium oxide (ITO), and antimony-doped tin oxide (ATO). Among these particles, the first inorganic nanoparticles are preferably silica, alumina, and zirconium oxide, which have lower ultraviolet absorption ability at 350 nm compared to the second inorganic nanoparticles described below, and particularly preferably silica. The water-dispersible silica nanoparticles include a silanol group on their surfaces and thus can improve hydrophilicity of the transparent hydrophilic ultraviolet-absorbing layer than other particles.

Any commercially available product can be used as the first inorganic nanoparticles. For example, the following can be used: NALCO 2327 (available from Nalco Corporation) as silica particles; BIRAL AL-A7 (available from Taki Chemical Co., Ltd.) as alumina particles; BIRAL Zr-20 (available from Taki Chemical Co., Ltd.) as zirconium oxide; PI-3 (available from Mitsubishi Materials Electronic Chemicals Co., Ltd.) as tin-doped indium oxide; and 549541 (available from Sigma-Aldrich Co. LLC) as antimony-doped tin oxide.

From the perspective of hydrophilicity and scratch resistance, the first inorganic nanoparticles are preferably particles that are unmodified and can be dispersed in water in an unaggregated state. Examples of such inorganic nanoparticles that can be used include, but are not limited to, particles that can be dispersed in water only by electrostatic repulsion of the particle surface due to pH adjustment. Here, “unmodified” means that the end group on the inorganic nanoparticle surface is not modified with a functional group, and this includes, for example, a case where the inorganic nanoparticle surface is not treated to bond a surface treatment agent to the inorganic nanoparticle surface (bonding by covalent bonding, ionic bonding, or bonding by physical adsorption) to facilitate dispersion of the inorganic nanoparticles in water and the transparent hydrophilic ultraviolet-absorbing coating agent. The first inorganic nanoparticles not treated with a surface treatment agent, such as a polymer, and used in a state of exposing the surface of the inorganic nanoparticles (unmodified state), enables the surface of the transparent hydrophilic ultraviolet-absorbing layer containing the particles to exhibit more scratch resistance, hardness, and hydrophilicity inherent in the inorganic nanoparticles.

The amount of the first inorganic nanoparticles can be, for example, 10 mass % or greater, 20 mass % or greater, 30 mass % or greater, or 40 mass % or greater, and 65 mass % or less, 60 mass % or less, 55 mass % or less, or 50 mass % or less, based on the total weight (dry coating amount) of the transparent hydrophilic ultraviolet-absorbing layer or the total weight (solid content) of the transparent hydrophilic ultraviolet-absorbing coating agent. The first inorganic nanoparticles contained in such a proportion can reduce or prevent reductions in transparency and ultraviolet-shielding properties and can improve hydrophilicity and scratch resistance of the resulting transparent hydrophilic ultraviolet-absorbing layer. In addition, the transparent hydrophilic ultraviolet-absorbing layer can further improve durability and sustainability of hydrophilicity compared to hydrophilic coating layers formed by using an organic hydrophilicity-imparting agent.

The average particle size of the inorganic nanoparticles can be measured using techniques commonly used in the art, for example, transmission electron microscopy (TEM) and scanning electron microscopy (SEM). To measure the average particle size of the inorganic nanoparticles in a solution, such as a transparent hydrophilic ultraviolet-absorbing coating agent, TEM is advantageously used, and to measure the average particle size of the inorganic nanoparticles in the transparent hydrophilic ultraviolet-absorbing layer constituting the transparent hydrophilic ultraviolet-absorbing laminate, SEM, which can observe the cross section of the transparent hydrophilic ultraviolet-absorbing layer, is advantageously used. The average particle size according to these measurement methods can be defined as an average value of from 10 or greater, for example, from 10 to 100 particles. An example of the measurement method by TEM will be described below.

In measuring the average particle size of the inorganic nanoparticles by TEM, a sol sample for a TEM image can be prepared by dropping a sol sample onto a 400-mesh copper TEM grid including an ultra-thin carbon substrate on the top surface of a mesh lacey carbon (available from Ted Pella Inc. (Redding, Calif.)). Some of the droplets can be removed by bringing the droplets together with filter paper into contact with the side or bottom of the grid. The remainder of the solvent of the sol can be removed by heating or allowing it to stand at room temperature. This enables the particles to remain on the ultra-thin carbon substrate and be imaged with minimal interference from the substrate. The TEM image can then be recorded at many locations throughout the entire grid. For example, sufficient number of images can be recorded to enable particle sizes from 500 to 1000 particles to be measured. The average particle size of the inorganic nanoparticles can then be calculated based on the particle size measurement value for each sample.

The TEM image can be obtained using, for example, a high-resolution transmission electron microscope (available from Hitachi High-Technologies Corporation under the trade designation “Hitachi H-9000”) operating at 300 KV (using an LaB₆ source). The image can be recorded using a camera (e.g., available from Gatan, Inc. (Pleasanton, Calif.) under the trade designation “GATAN ULTRASCAN CCD”: Model No. 895, 2k×2k chips). The image can be taken at magnifications of 50,000-fold and 100,000-fold. For some samples, the image can be taken at a magnification of 300,000-fold.

In some embodiments, the average particle size of the first inorganic nanoparticles can be, for example, 15 nm or greater, 20 nm or greater, 30 nm or greater, or 50 nm or greater. The upper limit value of the average particle size of the first inorganic nanoparticles is not particularly limited but can be, for example, 300 nm or less, 250 nm or less, 200 nm or less, 150 nm or less, or 100 nm or less. The first inorganic nanoparticles having such an average particle size, when employed, can reduce or prevent reductions in transparency and ultraviolet-shielding properties and can improve hydrophilicity and scratch resistance of the resulting transparent hydrophilic ultraviolet-absorbing layer.

The second inorganic nanoparticles are core-shell ultraviolet-absorbing particles different from the first inorganic nanoparticles described above, and the shell contains silicon oxide. Such a particle is coated around the core particle with a shell containing silicon oxide. Such inorganic nanoparticles are more hydrophilic than organic ultraviolet absorbers and thus can be contained in a coating agent containing at least one selected from a hydrophilic binder, a hydrophilic curable monomer, and a hydrophilic curable oligomer and can improve transparency (can particularly reduce haze) compared to ultraviolet-absorbing particles, such as zinc oxide, that include no shell layer.

The core particles are not particularly limited, and any inorganic nanoparticles having ultraviolet absorption ability can be used, but from the perspectives, for example, such as ultraviolet-absorbing properties and handleability, titanium oxide (TiO₂) and zinc oxide (ZnO) are preferred, and zinc oxide is more preferred. These can be used alone or in combination.

The shell needs to contain silicon oxide, and the proportion of the silicon oxide component in the shell can be, but not limited to, for example, 50% or greater, 70% or greater, or 90% or greater, and the shell desirably consists of only silicon oxide. The shell containing silicon oxide in such a proportion can prevent degradation of the hydrophilic binder due to, for example, the photocatalytic ability of zinc oxide, thus can improve durability of the coating layer and dispersibility in or compatibility with the hydrophilic binder, and thus this can provide a coating layer having excellent transparency.

The shell can be applied to at least a portion of the core particle surface, for example, in a range of 50% or greater, 60% or greater, 70% or greater, 80% or greater, or 90% or greater of the core particle surface, but in view of preventing deterioration of the hydrophilic binder due to the photocatalytic ability, dispersibility to the hydrophilic binder, and the like, the shell is advantageously applied to the entire surface of the core particle.

The thickness of the shell is not particularly limited, but from the perspectives, for example, such as ultraviolet-absorbing properties, prevention of deterioration of the hydrophilic binder due to the photocatalytic ability, and dispersibility in the hydrophilic binder, the thickness of the shell can be 0.5 nm or greater, 1 nm or greater, 2 nm or greater, 3 nm or greater, or 5 nm or greater, and can be 25 nm or less, 20 nm or less, or 15 nm or less.

The method for applying the shell to the core particle surface is not particularly limited, but the core-shell particles can be prepared, for example, by adding a predetermined amount of a silicate salt, such as tetraethyl orthosilicate (TEOS), to an aqueous suspension containing core particles, such as zinc oxide, and stirring and optionally heating the suspension. Alternatively, the core-shell particles can be prepared by adding L-lysine to an aqueous suspension containing core particles, stirring and optionally heating the suspension to surface-modify the core particle surface with L-lysine, then adding a predetermined amount of a silicate salt, such as TEOS, and stirring and optionally heating the suspension. The latter method can provide nanoparticles of relatively uniform particle size, and thus this can reduce or prevent a reduction in transparency, for example, a reduction in light transmittance in the visible light region or an increase in haze.

Inorganic nanoparticles are nano-order particles, thus typically have high surface activity and tend to aggregate and settle in the coating agent. In particular, zinc oxide and titanium oxide coated with the shell layer still have such a strong tendency, and thus in mixing such particles with a resin component, such as a resin binder or a monomer, the surface of the shell layer is typically modified with a surface treatment agent, such as a silane coupling agent as described in Examples of Patent Document 3 from the perspective of dispersibility or compatibility of the particles in the resin component, and the transparency associated with the dispersibility or compatibility. However, it has been found that the coating agent of the present disclosure containing at least one selected from the hydrophilic binder, the hydrophilic curable monomer, and the hydrophilic curable oligomer can, on the contrary, reduce hydrophilicity and transparency (in particular, increase haze) if the second inorganic nanoparticles in which the shells are modified with a surface treatment agent, such as a silane coupling agent, are used.

The present inventor has found that the coating agent of the present disclosure containing at least one selected from the hydrophilic binder, the hydrophilic curable monomer, and the hydrophilic curable oligomer can reduce or prevent the agglomeration and precipitation of the inorganic nanoparticles in the coating agent on the contrary to the previous tendency when the modified amount (coating proportion) with a surface treatment agent on the shell surface of the second inorganic nanoparticles is preferably 20% or less, 15% or less, or 10% or less, or the shell surface is more preferably unmodified. The use of such second inorganic nanoparticles can further improve transparency, hydrophilicity, and ultraviolet-shielding properties of the coating layer.

The presence or absence of a surface treatment agent on the shell surface in the coating agent can be measured using, for example, X-ray photoelectron spectroscopy (XPS) or nuclear magnetic resonance (NMR) while the presence or absence of a surface treatment agent on the shell surface in the coating layer formed by the coating agent may not be able to be measured. However, the inorganic nanoparticles modified in a proportion exceeding the acceptable modified amount, where used, would reduce hydrophilicity of the coating layer, and thus the water contact angle of the coating layer surface fails to achieve 30.0 degrees or less. Thus, the presence or absence of the modification treatment of the inorganic nanoparticles can be indirectly evaluated by the water contact angle of the coating layer surface.

The amount of the second inorganic nanoparticles can be, for example, 10 mass % or greater, 20 mass % or greater, 30 mass % or greater, or 40 mass % or greater, and 65 mass % or less, 60 mass % or less, 55 mass % or less, or 50 mass % or less, based on the total weight (dry coating amount) of the transparent hydrophilic ultraviolet-absorbing layer or the total weight (solid content) of the transparent hydrophilic ultraviolet-absorbing coating agent. The second inorganic nanoparticles contained in such a proportion can reduce or prevent reductions in transparency and hydrophilicity and can improve ultraviolet-shielding properties and scratch resistance of the resulting transparent hydrophilic ultraviolet-absorbing layer.

In some embodiments, the average particle size of the second inorganic nanoparticles may be greater than the average particle size of the first inorganic nanoparticles described above. In some embodiments, the average particle size of the second inorganic nanoparticles can be, for example, 50 nm or greater, 60 nm or greater, 70 nm or greater, or 80 nm or greater. The upper limit value of the average particle size of the second inorganic nanoparticles is not particularly limited but can be, for example, 400 nm or less, 350 nm or less, 300 nm or less, 250 nm or less, 200 nm or less, or 150 nm or less. The second inorganic nanoparticles having such an average particle size, when employed, can reduce or prevent reductions in transparency and hydrophilicity and can improve ultraviolet-shielding properties and scratch resistance of the resulting transparent hydrophilic ultraviolet-absorbing layer.

The total amount of the first inorganic nanoparticles and the second inorganic nanoparticles can be, for example, 70 mass % or greater, 75 mass % or greater, 77 mass % or greater, or 80 mass % or greater, and 95 mass % or less, 90 mass % or less, or 85 mass % or less, based on the total weight (dry coating amount) of the transparent hydrophilic ultraviolet-absorbing layer or the total weight (solid content) of the transparent hydrophilic ultraviolet-absorbing coating agent. The inorganic nanoparticles contained in such a large amount can improve hydrophilicity, ultraviolet-shielding properties, and scratch resistance of the resulting transparent hydrophilic ultraviolet-absorbing layer and, in addition, can further improve durability and sustainability of hydrophilicity and ultraviolet-shielding properties compared to transparent hydrophilic ultraviolet-absorbing layers formed by using mainly an organic hydrophilicity-imparting agent and an organic ultraviolet absorber.

The transparent hydrophilic ultraviolet-absorbing layer can be applied to one or both sides of the substrate. The thickness of the transparent hydrophilic ultraviolet-absorbing layer is not particularly limited and can be, for example, 0.1 micrometers or greater, 0.5 micrometers or greater, or 1 micrometer or greater. The upper limit value of the thickness is not particularly limited but can be, for example, 20 micrometers or less, 15 micrometers or less, or 10 micrometer or less.

In some embodiments, each of the first inorganic nanoparticles and the second inorganic nanoparticles may be a mixture of inorganic nanoparticles having different average particle sizes. For example, in using the first inorganic nanoparticles having an average particle size of 15 nm or greater or the second inorganic nanoparticles having an average particle size of 50 nm or greater, the first inorganic nanoparticles and the second inorganic nanoparticles having an average particle size smaller than those of the above particles may be used in combination. For example, a silica sol having an average particle size of 75 nm and a silica sol having an average particle size of 5 nm can be used in a mixture as the first inorganic nanoparticles. With such a configuration, the inorganic nanoparticles can be highly filled into the transparent hydrophilic ultraviolet-absorbing layer, and thus this can further improve durability, hardness, scratch resistance, and the like of the transparent hydrophilic ultraviolet-absorbing layer.

Performance, such as hydrophilicity, transparency, ultraviolet-shielding properties, durability, scratch resistance, and hardness can be adjusted by selecting the type, amount, size, and mixing ratio of the first inorganic nanoparticles and the second inorganic nanoparticles.

The transparent hydrophilic ultraviolet-absorbing layer can contain an optional component, such as a silane coupling agent, a flame retardant, an antioxidant, an antistatic agent, a light stabilizer, a thermal stabilizer, a dispersant, a surfactant, a leveling agent, a catalyst, a pigment, and a dye, alone or in combination of two or more within the range not inhibiting the effects of the present embodiment.

Examples of the silane coupling agent (which may be referred to as the “first silane coupling agent”) that can be used include hydrophilic silane coupling agents, including: an amino-modified alkoxysilane; an epoxy-modified alkoxysilane, such as a glycidyl-modified alkoxysilane; a polyether-modified alkoxysilane; and a zwitterionic alkoxysilane. The silane coupling agent, when contained in the transparent hydrophilic ultraviolet-absorbing layer, can bond the inorganic nanoparticles and the hydrophilic binder, and thus this can prevent the inorganic nanoparticles from falling off from the transparent hydrophilic ultraviolet-absorbing layer. The use of the silane coupling agent is also useful for improving the interlayer adhesion between the substrate and the transparent hydrophilic ultraviolet-absorbing layer when an inorganic substrate, such as glass, is employed.

In the case of modifying the inorganic nanoparticles with a surface treatment agent, such as a silane coupling agent, as described in Examples of Patent Document 3, the silane coupling agent is typically added directly to the sol containing the inorganic nanoparticles coated with the shell as exemplified also in the section of Examples below, and thus the silane coupling agent is coated on the shell surface in high density. On the other hand, in the case of using a silane coupling agent by adding it to the coating agent containing the first inorganic nanoparticles, the second inorganic nanoparticles, and the hydrophilic monomer, the coating proportion of the silane coupling agent on the surface of the second inorganic nanoparticles contained in the coating agent is obviously less than that of the system of the modification treatment. As a result of such a difference in the coating state of the silane coupling agent on the shell surface, the silane coupling agent, when used by adding it to the coating agent, is thought unlikely to reduce transparency.

The silane coupling agent can be used typically in a range of 0.1 mass % or greater, 0.2 mass % or greater, or 0.3 mass % or greater, and 2.0 mass % or less, 1.5 mass % or less, or 1.0 mass % or less, based on the total weight (dry coating weight) of the transparent hydrophilic ultraviolet-absorbing layer or the total weight (solid content) of the transparent hydrophilic ultraviolet-absorbing coating agent. With such a proportion, even if the silane coupling agent adheres to the shell surface of the second inorganic nanoparticles, the proportion of the adhesion would be small, and thus the silane coupling agent would not cause such a problem as increasing the haze.

Among others, the hydrophilic silane coupling agent described above can be present in a well-balanced manner between the hydrophilic binder or the hydrophilic curable monomer or oligomer and the inorganic nanoparticles rather than preferentially attaching to the surface of the inorganic nanoparticles, and thus this is thought to be able to reduce or prevent such a problem as increasing the haze. For example, a hydrophilic silane coupling agent including a vinyl group, or a (meth)acryl group can be used also as the hydrophilic binder. The hydrophilic silane coupling agent that can also function as the hydrophilic binder can be used in a range of 5 mass % or greater, 10 mass % or greater, or 15 mass % or greater, and 25 mass % or less, 23 mass % or less, or 20 mass % or less, based on the total weight (dry coating weight) of the transparent hydrophilic ultraviolet-absorbing layer or the total weight (solid content) of the transparent hydrophilic ultraviolet-absorbing coating agent.

In some embodiments, the transparent hydrophilic ultraviolet-absorbing layer of the transparent hydrophilic ultraviolet-absorbing laminate can be highly filled with the first inorganic nanoparticles and the second inorganic nanoparticles and thus can also exhibit excellent surface hardness and scratch resistance in addition to the transparency, hydrophilicity, and ultraviolet-shielding properties.

The hydrophilicity of the transparent hydrophilic ultraviolet-absorbing laminate can be evaluated by water contact angle. For example, the water contact angle of the transparent hydrophilic ultraviolet-absorbing layer surface of such a laminate can be 30.0 degrees or less, 25.0 degrees or less, 20.0 degrees or less, or 15.0 degrees or less. The lower limit value of the water contact angle is not particularly limited but can be, for example, 1.0 degree or greater, 2.0 degrees or greater, or 3.0 degrees or greater.

The transparency of the transparent hydrophilic ultraviolet-absorbing laminate can be evaluated, for example, by haze or light transmittance test. Haze can be measured in accordance with JIS K 7136 (2000) and light transmittance in accordance with JIS K 7361-1 (1997) using NDH-5000W (available from Nippon Denshoku Industries Co., Ltd.).

When a transparent hydrophilic ultraviolet-absorbing laminate formed by applying a 1.0-micrometer thick transparent hydrophilic ultraviolet-absorbing layer to one side of a typical transparent optical film substrate, for example, a 50-micrometer thick COSMOSHINE A4100 (available from Toyobo Co., Ltd.) is used as a sample, the initial haze value can be 5.0% or lower, 4.0% or lower, or 3.0% or lower. The lower limit value of the initial haze value is not particularly limited but can be, for example, 0.5% or higher, 0.7% or higher, or 1.0% or higher.

The light transmittance in the visible light region (wavelength from 400 to 700 nm) can be 85.0% or higher, 87.0% or higher, or 90.0% or higher. The upper limit value of such a light transmittance is not particularly limited but can be, for example, lower than 100%, 99.0% or lower, or 98.0% or lower.

The diffuse transmittance in the visible light region (wavelength from 400 to 700 nm) can be 5.0% or lower, 4.0% or lower, or 3.0% or lower. The upper limit value of the diffuse transmittance is not particularly limited but can be, for example, higher than 0%, 0.1% or higher, or 0.2% or higher.

The parallel light transmittance in the visible light region (wavelength from 400 to 700 nm) can be 80.0% or higher, 83.0% or higher, or 85.0% or higher. The upper limit value of the parallel light transmittance is not particularly limited but can be, for example, 94.0% or lower, 93.0% or lower, or 92.0% or lower.

The ultraviolet-shielding performance of the transparent hydrophilic ultraviolet-absorbing laminate can be evaluated by the light transmittance in the ultraviolet region (e.g., 350 nm). Such light transmittance can be measured in accordance with JIS K 7361-1 (1997), respectively, using NDH-5000W (available from Nippon Denshoku Industries Co., Ltd.).

When a transparent hydrophilic ultraviolet-absorbing laminate formed by applying a 1.0-micrometer thick transparent hydrophilic ultraviolet-absorbing layer to one side of a typical transparent optical film substrate, for example, a 50-micrometer thick COSMOSHINE A4100 (available from Toyobo Co., Ltd.) is used as a sample, the light transmittance in the ultraviolet region (350 nm) can be 75.0% or lower, 60.0% or lower, 50.0% or lower, or 40.0% or lower. The lower limit value of such light transmittance is not particularly limited but can be, for example, 5.0% or higher, 10.0% or higher, 15.0% or higher, 20.0% or higher, or 25.0% or higher.

The surface hardness of the transparent hydrophilic ultraviolet-absorbing laminate can be evaluated, for example, by pencil hardness in accordance with JIS K5600-5-4. For example, when a clear hydrophilic ultraviolet-absorbing laminate formed by applying a 1.0-micrometer thick transparent hydrophilic ultraviolet-absorbing layer to one side of a PET film substrate is used as a sample, and such a sample is fixed on a glass plate and measured by scratching with a tip of a pencil lead with a load of 750 g at a speed of 600 mm/min, the pencil hardness can be 4B or greater, 2B or greater, or H or greater, and can be 4 H or less, 3 H or less, or 2 H or less.

The scratch resistance of the transparent hydrophilic ultraviolet-absorbing laminate can be evaluated, for example, by steel wool abrasion resistance test. Such a test can be evaluated using, for example, a steel wool abrasion resistance tester (Rubbing Tester IMC-157C, available from Imoto Machinery Co., Ltd.) and by grinding the surface of the transparent hydrophilic ultraviolet-absorbing layer of the transparent hydrophilic ultraviolet-absorbing laminate 10 times (cycles) using a 27-mm square #0000 steel wool with a load of 350 g, at a stroke of 85 mm, and at a speed of 60 cycles/min, and by Δhaze value (haze value after abrasion test-initial haze value) based on the haze measurement described above.

When a transparent hydrophilic ultraviolet-absorbing laminate formed by applying a 1.0-micrometer thick transparent hydrophilic ultraviolet-absorbing layer to one side of a typical transparent optical film substrate, for example, a 50-micrometer thick COSMOSHINE A4100 (available from Toyobo Co., Ltd.) is used as a sample, Ahaze value can be from −0.20% to 0.20%, from −0.15% to 0.15%, or from −0.10% to 0.10%.

In some embodiments, a surface treatment or a primer layer may be optionally applied to the substrate surface of the transparent hydrophilic ultraviolet-absorbing laminate of the present embodiment to improve adhesion between the transparent hydrophilic ultraviolet-absorbing layer and the substrate.

The surface treatment is known in the art, and examples thereof include surface treatments, such as a plasma treatment, a corona discharge treatment, a flame treatment, an electron beam irradiation treatment, a roughening treatment, an ozone treatment, and a chemical oxidation treatment using chromic acid or sulfuric acid.

The transparent hydrophilic ultraviolet-absorbing coating agent of the present embodiment is hydrophilic, and thus in using a substrate having a water repellent surface, for example, a surface having a water contact angle of 80 degrees or greater or 90 degrees or greater (e.g., an aluminum substrate), a primer layer having a water contact angle of 10 degrees or greater, 15 degrees or greater, or 20 degrees or greater, and 60 degrees or less, 50 degrees or less, or 40 degrees or less is preferably applied in view of coating properties of the transparent hydrophilic ultraviolet-absorbing coating agent. Such a primer layer can be formed, for example, using a primer coating agent containing inorganic nanoparticles (which may be referred to as third inorganic nanoparticles) and a silane coupling agent (which may be referred to as a second silane coupling agent).

The third inorganic nanoparticles and the second silane coupling agent used in the primer layer can be the same as the first inorganic nanoparticles and the first silane coupling agent described above. From the perspective of coating properties to the substrate and adhesion of the substrate and the transparent hydrophilic ultraviolet-absorbing layer, the third inorganic nanoparticles are advantageously silica particles.

Also, in view of light resistance, fourth inorganic nanoparticles having ultraviolet-shielding ability are advantageously used in combination with the third inorganic nanoparticles. Examples of the fourth inorganic nanoparticles that can be used include zinc oxide and titanium oxide, which are described as the core particles of the second inorganic nanoparticles; however, from the perspective of preventing degradation of the primer layer associated with photocatalytic action, core-shell ultraviolet-absorbing particles similar to the second inorganic nanoparticles are advantageously used.

The second silane coupling agent is advantageously a silane coupling agent including, for example, a vinyl group or a (meth)acryl group, which can also function as a binder from the perspective of coating properties to the substrate and adhesion of the substrate and the transparent hydrophilic ultraviolet-absorbing layer.

The content of the third inorganic nanoparticles in the primer layer or the total content of the third inorganic nanoparticles and the fourth inorganic nanoparticles in the primer layer is advantageously less than the total content of the first inorganic nanoparticles and the second inorganic nanoparticles in the transparent hydrophilic ultraviolet-absorbing layer from the perspective of coating properties to the substrate and adhesion of the substrate and the transparent hydrophilic ultraviolet-absorbing layer.

The primer layer can be formed by coating a primer coating agent containing inorganic nanoparticles and a silane coupling agent onto a substrate by a known method in the art, for example, bar coating, dip coating, spin coating, capillary coating, spray coating, gravure coating, and screen printing, and drying.

The thickness of the primer layer is not particularly limited and can be, for example, 0.1 micrometers or greater, or 0.5 micrometers or greater, and can be 20 micrometers or less, 10 micrometers or less, or 5 micrometers or less.

In some embodiments, an additional layer, such as a colored layer, a decorative layer, an electrically conductive layer, an adhesive layer, or a tackifier layer, may be optionally applied to the transparent hydrophilic ultraviolet-absorbing laminate of the present embodiment, for example, between the transparent hydrophilic ultraviolet-absorbing layer and the substrate or onto the substrate surface opposite to the transparent hydrophilic ultraviolet-absorbing layer.

The transparent hydrophilic ultraviolet-absorbing laminate of the present embodiment may be, for example, a sheet product, a roll product wound in a roll shape, or a three-dimensionally shaped article.

The method for producing the transparent hydrophilic ultraviolet-absorbing laminate is not particularly limited, and the transparent hydrophilic ultraviolet-absorbing laminate can be produced, for example, through steps of: coating the transparent hydrophilic ultraviolet-absorbing coating agent to a substrate optionally including a primer layer and drying the transparent hydrophilic ultraviolet-absorbing coating agent to form an uncured transparent hydrophilic ultraviolet-absorbing layer; and curing the uncured transparent hydrophilic ultraviolet-absorbing layer.

The transparent hydrophilic ultraviolet-absorbing coating agent of the present embodiment is a coating agent that can contain various materials that can be used in the transparent hydrophilic ultraviolet-absorbing layer described above and contains at least first inorganic nanoparticles, second inorganic nanoparticles, and at least one selected from a hydrophilic binder, a hydrophilic curable monomer, and a hydrophilic curable oligomer, in which a transparent hydrophilic ultraviolet-absorbing layer formed by the transparent hydrophilic ultraviolet-absorbing coating agent exhibits a water contact angle of 30.0 degrees or less.

In some embodiments, the transparent hydrophilic ultraviolet-absorbing coating agent can further contain water and an organic solvent compatible with water. Here, “compatible with water” means that water and the organic solvent are uniformly mixed without being separated from each other. The solubility parameter (SP) value of the organic solvent miscible with water is, for example, 9.3 or greater or 10.2 or greater, and less than 23.4.

In some embodiments, the transparent hydrophilic ultraviolet-absorbing coating agent can be obtained, for example, by mixing sols of the first and second inorganic nanoparticles, which are water-dispersible, with a hydrophilic curable monomer together with an initiator in a solvent and adjusting to the desired solid content by adding a solvent as necessary. Examples of the initiator that can be used include a known photopolymerization initiator or thermal polymerization initiator described above.

For example, the unmodified water-dispersible inorganic nanoparticles are dispersed in a sol solely by electrostatic repulsion between the particles. Such inorganic nanoparticles, when contained in the transparent hydrophilic ultraviolet-absorbing coating agent containing at least one selected from the hydrophilic binder, the hydrophilic curable monomer, and the hydrophilic curable oligomer, may cause the inorganic nanoparticles to aggregate and increase particle size, and reduce performance of the resulting transparent hydrophilic ultraviolet-absorbing layer, such as transparency. In a production method of one embodiment, the solvent used in adjusting the transparent hydrophilic ultraviolet-absorbing coating agent is selected, and this enables the unmodified water-dispersible inorganic nanoparticles to be dispersed in the transparent hydrophilic ultraviolet-absorbing coating agent.

Examples of the solvent that can be used include a mixed solvent of water and an organic solvent compatible with water. The amount of water in the mixed solvent can be 30 mass % or greater, 35 mass % or greater, 40 mass % or greater, 50 mass % or greater, or 60 mass % or greater, based on the total weight of the transparent hydrophilic ultraviolet-absorbing coating agent. Examples of the organic solvent compatible with water that can be used include at least one, such as methanol, ethanol, isopropanol, or 1-methoxy-2-propanol. Among them, the organic solvent is preferably 1-methoxy-2-propanol mixed with at least one of methanol, ethanol, or isopropanol.

The mass ratio of water and the organic solvent compatible with water can be, for example, 30:70, 35:65, 40:60, 50:50, or 60:40. The mass ratio of 1-methoxy -2-propanol and at least one or more of methanol, ethanol, or isopropanol in the organic solvent compatible with water can be, for example, 95:5, 90:10, 80:20, 70:30, 60:40, 50:50, or 40:60.

Examples of the technique to apply the transparent hydrophilic ultraviolet-absorbing coating agent to the surface of the substrate include, but are not limited to, bar coating, dip coating, spin coating, capillary coating, spray coating, gravure coating, and screen printing.

The transparent hydrophilic ultraviolet-absorbing layer applied to the substrate is dried as necessary and can be cured by a polymerization method known in the art, such as a photopolymerization method using ultraviolet light or an electron beam or a thermal polymerization method. The transparent hydrophilic ultraviolet-absorbing layer is thus formed on the substrate, and the transparent hydrophilic ultraviolet-absorbing laminate of the present embodiment can be obtained.

The transparent hydrophilic ultraviolet-absorbing laminate of the present embodiment has an antifogging effect and an antifouling effect associated with hydrophilicity and has excellent transparency and ultraviolet-shielding performance and thus can be used in various applications regardless of indoor or outdoor use. Such applications are not particularly limited but include, for example, various components used in: windows, mirrors, bodies, or light covers of vehicles (e.g., cars, ships, trains, and aircrafts); window glasses, sachets, doors, door knobs, or exterior materials of buildings; faucet handles; home electric appliances (e.g., air conditioners, electric fans, vacuum cleaners, washing machines, and refrigerators); lenses or bodies of cameras; watches; optical displays (e.g., cathode-ray tubes (CRT), liquid crystal (LCD) displays, and light-emitting diode (LED) displays); mobile terminals (e.g., personal digital assistants (PDA), mobile phones, and smart phones); devices, such as keyboards, touch screens, and removable computer screens; traffic signals; mirrors, glasses, or goggles; cards; tableware; furniture (e.g., tables, chairs, and desks); packaging materials; bags; clothes; rain gear; measuring instruments or observation instruments; solar panels; and wind power generation.

### EXAMPLES

Specific embodiments of the present disclosure will be exemplified in the following examples, but the present invention is not limited to these embodiments. All parts and percentages are based on mass unless otherwise specified.

Various properties were evaluated according to the following method.

### Transparency: Light Transmittance Test in Visible Light Region

Optical properties related to the transparency of the test samples were each measured in accordance with JIS K 7136 (2000) and JIS K 7361-1 (1997) using NDH-5000W (available from Nippon Denshoku Industries Co., Ltd.). The results are shown in Table 3. Here, as the optical properties related to the transparency, haze and light transmittance (TT), diffuse transmittance (DF), and parallel light transmittance (PT) in the visible light region (wavelength from 400 to 700 nm) were evaluated.

### Ultraviolet-Shielding Properties: Light Transmittance Test in Ultraviolet Region

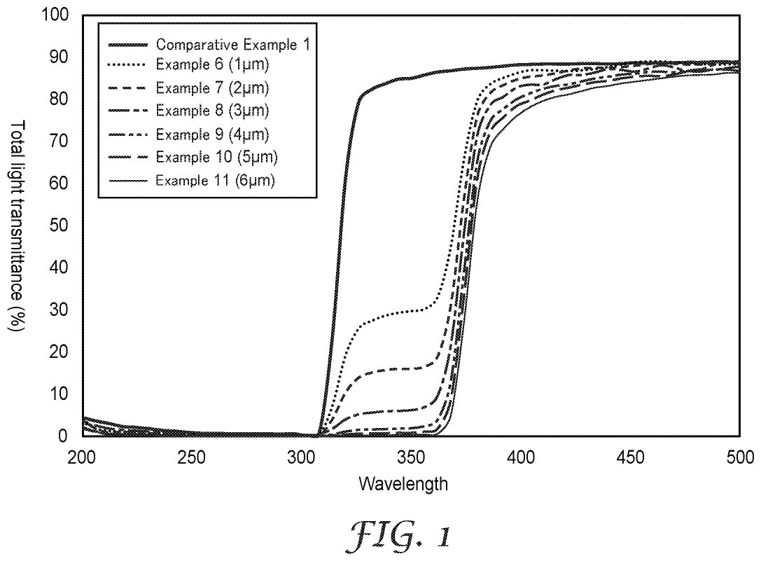

Optical properties related to the ultraviolet-shielding properties of the test samples were each measured in accordance with JIS K 7361-1 (1997) using NDH-5000W (available from Nippon Denshoku Industries Co., Ltd.). The results are shown in Table 3 and illustrated in FIG. 1. Here, as the optical properties related to the ultraviolet-shielding properties, light transmittance in the ultraviolet region (wavelength of 350 nm) was evaluated.

### Water Contact Angle

The water contact angle of the coating layer surface was measured using a contact angle meter (obtained from Kyowa Interface Science Co., Ltd. under the trade designation “DROPMASTER FACE”) by Sessile Drop method. After 2 microliters of water was dropped to the surface of the test sample, the water contact angle was measured from the optical microscope image. The water contact angle value was calculated from the average measured five times. The results are shown in Table 3.

### Adhesion

The adhesion performance between the substrate and the coating layer was evaluated according to the cross-cut method in accordance with JIS K 5600. Here, a 5×5 grid with a grid spacing of 1 mm and a CELLOTAPE CT-24 (available from Nichiban Co., Ltd.) were employed. A sample having no peeling in the coating layer was rated “good”, and a sample having peeling in the coating layer was rated “poor”. The results are shown in Table 3.

The materials used in the present examples are shown in Table 1.

TABLE 1

| Trade name, | | |
|---|---|---|
| model | | |
| No., or | | |
| abbreviation | Description | Source of supply |
| NALCO 2329 | Unmodified SiO₂ sol, average | NALCO (USA) |
| | particle size: 75 nm, solid content: | |
| | 33.8 mass % | |
| NALCO 2327 | Unmodified SiO₂ sol, average | NALCO (USA) |
| | particle size: 20 nm, solid content: | |
| | 42.2 mass % | |
| NALCO 2326 | Unmodified SiO₂ sol, average | NALCO (USA) |
| | particle size: 5 nm, solid content: | |
| | 16.3 mass % | |
| EBECRYL 11 | Hydrophilic curable monomer: | Daicel-Allnex Ltd. (Chuo-ku, |
| | polyethylene glycol 600 diacrylate | Tokyo, Japan) |
| L-Lysine | Surface modifier | FUJIFILM Wako Pure Chemical |
| | | Corporation (Chuo-ku, Osaka-shi, |
| | | Japan) |
| AQ-E3913 | Unmodified ZnO sol, average | Resino Color Industry Co., Ltd. |
| | particle size 100 nm, solid content | (Yodogawa-ku, Osaka-shi, Japan) |
| | 39.51 mass % | |
| TEOS | Tetraethyl orthosilicate | FUJIFILM Wako Pure Chemical |
| | | Corporation (Chuo-ku, Osaka-shi, |
| | | Japan) |
| SAC | Silane coupling agent: | 3M Company (US) |
| | CH2═CH—(CO)O—(CH₂)₂—O(CO)—NH—(CH₂)₃—Si(OCH₃)₃ | |
| SILQUEST | Silane coupling agent: 3- | Alfa Aesar (US) |
| A-174 | methacryloxypropyltrimethoxysilane | |
| IRGACURE | Photopolymerization initiator: 1-[4- | BASF Japan Ltd. (Minato-ku, |
| 2959 | (2-hydroxyethoxy)-phenyl]-2- | Tokyo, Japan) |
| | hydroxy-2-methyl-1-propan-1-on | |
| TINUVIN 477 | About 80% hydroxyphenyltriazine | BASF Japan Ltd. (Minato-ku, |
| | (HPT) ultraviolet absorber, about | Tokyo, Japan) |
| | 20% 1-methoxy-2-propyl-acetate | |
| TINUVIN 479 | Hydroxyphenyltriazine (HPT) | BASF Japan Ltd. (Minato-ku, |
| | ultraviolet absorber | Tokyo, Japan) |
| TINUVIN | Hydroxyphenyltriazine (HPT) | BASF Japan Ltd. (Minato-ku, |
| 477 DW | ultraviolet absorber dispersed in water | Tokyo, Japan) |
| TINUVIN | Hydroxyphenyltriazine (HPT) | BASF Japan Ltd. (Minato-ku, |
| 479 DW | ultraviolet absorber dispersed in water | Tokyo, Japan) |
| MIPA | 1-Methoxy-2-propanol | FUJIFILM Wako Pure Chemical |
| | | Corporation (Chuo-ku, Osaka-shi, |
| | | Japan) |
| EtOH | Ethanol | FUJIFILM Wako Pure Chemical |
| | | Corporation (Chuo-ku, Osaka-shi, |
| | | Japan) |
| IPA | 2-Propanol | FUJIFILM Wako Pure Chemical |
| | | Corporation (Chuo-ku, Osaka-shi, |
| | | Japan) |
| COSMOSHINE | 50-micrometer thick PET film, a | Toyobo Co., Ltd. (Kita-ku, |
| A4100 | product on which one side is easy | Osaka-shi, Japan) |
| | adhesion-treated | |

### Preparation of SAC

A SAC was prepared by the method described in Preparative Example 7 described in US 2015/0,203,708 A (Klun et al.). Specifically, a 500-mL round-bottom flask equipped with an overhead stirrer was charged with 140.52 g (0.684 mol, weight average molecular weight of 205.28) of 3-trimethoxysilyl propyl isocyanate and 0.22 g of dibutyl tin dilaurate (DBTDL) and heated to 55° C. Using an addition funnel, 79.48 g (0.684 mol, weight average molecular weight of 116.12) of hydroxyethyl acrylate was added over about 1 hour. At a total of about 4 hours, the product was isolated and bottled. Here, the weight average molecular weight was determined by gel permeation chromatography (GPC) using standard polystyrene.

### Preparation of SiO₂-Coated ZnO Sol

To a mixture of 20 g of AQ-E3913 and 20 g of EtOH in a glass bottle, 0.073 g of L-lysine was added, and the mixture was stirred at room temperature for 10 minutes. The glass bottle was sealed and placed in an oil bath at 60° C. while the mixture in the glass bottle was stirred for 16 hours, and a ZnO sol containing ZnO nanoparticles surface-modified with L-lysine (hereinafter, referred to as Sol 1) was obtained.

To 20 g of Sol 1 in the glass bottle, 20 g of a mixture of water and EtOH (mass ratio of water and EtOH of 1:1) was added. Then 5.104 g of TEOS was added into the glass bottle, and the mixture was prepared by stirring at room temperature for 10 minutes. The mixture was transferred into a sealable cylindrical polytetrafluoroethylene-lined stainless-steel autoclave and heated at 150° C. for 6 hours, and an SiO₂-coated ZnO sol (hereinafter, referred to as Sol 2) was obtained.

EtOH was removed from the resulting Sol 2 with a rotary evaporator at 60° C. until the solid content of the solution was close to 10 mass %. To the resulting solution, 40 g of distilled water was charged, and then the remaining EtOH was removed using a rotary evaporator at 60° C. The latter step was repeated twice, and EtOH was further removed from the solution. The concentration of total ZnO nanoparticles was adjusted to 27.0 mass %, and an SiO₂-coated ZnO sol dispersed in water (hereinafter, referred to as the unmodified SiO₂-coated ZnO sol) was obtained.

Preparation of SiO₂-Coated ZnO Sol Treated with Silane Coupling Agent

Sol 2 was prepared in the same manner as described above, 0.465 g of SILQUEST A-174 and 0.0125 g of PROSTAB were added to Sol 2 in a glass bottle, and the mixture was stirred at room temperature for 10 minutes. The glass bottle was sealed and allowed to stand in an oven at 60° C. for 16 hours. Then, 20.0 g of MIPA was added, and water and EtOH were removed from the resulting solution using a rotary evaporator at 60° C. until the solid content of the solution was close to 40 mass %. To the resulting solution, 20 g of MIPA was charged, and then the remaining water was removed using a rotary evaporator at 60° C. The latter step was repeated twice, and water was further removed from the solution. The concentration of total ZnO nanoparticles was adjusted to 27.36 mass %, and an SiO₂-coated ZnO sol modified with 3-methacryloxypropyltrimethoxysilane (hereinafter, referred to as the modified SiO₂-coated ZnO sol) was obtained.

### Preparation of Coating Agent 1

First, 3.073 g of NALCO 2329, 1.329 g of NALCO 2327, 0.392 g of EBECRYL 11, and 0.008 g of SAC were mixed. To the mixture, 0.06 g of IRGACURE 2959 as a photopolymerization initiator was added. Then, 1.600 g of IPA, 2.400 g of MIPA, and 1.198 g of distilled water were added to the mixture, and Coating Agent 1 was prepared.

### Preparation of Coating Agent 2

First, 3.073 g of NALCO 2329, 1.329 g of NALCO 2327, 0.392 g of EBECRYL 11, and 0.008 g of SAC were mixed. To the mixture, 0.06 g of IRGACURE TM 2959, a photopolymerization initiator, and 0.5 g of TINUVIN 477 DW, a water-dispersible organic ultraviolet absorber, were added. Then, 1.600 g of IPA, 2.400 g of MIPA, and 1.198 g of distilled water were added to the mixture, and Coating Agent 2 was prepared. Note that TINUVIN 477, which is not a water-dispersible ultraviolet absorber, did not dissolve in the mixture, and thus a coating agent containing such an ultraviolet absorber was not able to be obtained.

### Preparation of Coating Agent 3

Coating Agent 3 was prepared in the same manner as Coating Agent 2 except for employing the content proportions shown in Table 2 below. Note that the contents in Table 2 are all in grams. In addition, TINUVIN 479, which is not a water-dispersible ultraviolet absorber, did not dissolve in the mixture, and thus a coating agent containing such an ultraviolet absorber was not able to be obtained.

### Preparation of Coating Agents 4 to 12

Coating Agents 4 to 12 were prepared in the same manner as Coating Agent 1 except for employing the content proportions shown in Table 2 below. Here, NALCO 2326, and the unmodified SiO₂-coated ZnO sol, the modified SiO₂-coated ZnO sol, or the unmodified ZnO sol (AQ-E3913) were mixed together with NALCO 2329 and the like.

TABLE 2

| | | Coating agent (g) | | | | | | | | | | | |
|---|---|---|---|---|---|---|---|---|---|---|---|---|---|
| Composition | | 1 | 2 | 3 | 4 | 5 | 6 | 7 | 8 | 9 | 10 | 11 | 12 |
| Inorganic | NALCO 2329 (average | 3.073 | 3.073 | 3.073 | 3.417 | 2.962 | 2.506 | 2.050 | 1.595 | 1.139 | 0.683 | 2.050 | 2.050 |
| nanoparticles | particle size: | | | | | | | | | | | | |
| | 75 nm, solid content: 33.8 mass %) | | | | | | | | | | | | |
| | NALCO 2327 (average | 1.329 | 1.329 | 1.329 | — | — | — | — | — | — | — | — | — |
| | particle size: | | | | | | | | | | | | |
| | 20 nm, solid content: 42.2 mass %) | | | | | | | | | | | | |
| | NALCO 2326 (average | — | — | — | 2.113 | 1.831 | 1.549 | 1.268 | 0.986 | 0.704 | 0.423 | 1.268 | 1.268 |
| | particle size: | | | | | | | | | | | | |
| | 5 nm, solid content: 16.3 mass %) | | | | | | | | | | | | |
| | Unmodified SiO₂-coated ZnO sol, | — | — | — | — | 0.741 | 1.481 | 2.222 | 2.963 | 3.704 | 4.444 | — | — |
| | solid content: 27.0 mass % | | | | | | | | | | | | |
| | Modified SiO₂-coated ZnO sol, | — | — | — | — | — | — | — | — | — | — | 2.193 | — |
| | solid content: 27.36 mass % | | | | | | | | | | | | |
| | AQ-E3913 (unmodified ZnO sol), | — | — | — | — | — | — | — | — | — | — | — | 1.591 |
| | average particle size: 100 nm, solid | | | | | | | | | | | | |
| | content: 39.51 mass % | | | | | | | | | | | | |
| Hydrophilic curable | EBECRYL 11 | 0.392 | 0.392 | 0.392 | 0.490 | 0.490 | 0.490 | 0.490 | 0.490 | 0.490 | 0.490 | 0.490 | 0.490 |
| monomer | | | | | | | | | | | | | |
| Silane coupling agent | SAC | 0.008 | 0.008 | 0.008 | 0.010 | 0.010 | 0.010 | 0.010 | 0.010 | 0.010 | 0.010 | 0.010 | 0.010 |
| Photopolymerization | IRGACURE 2959 | 0.060 | 0.060 | 0.060 | 0.100 | 0.100 | 0.100 | 0.100 | 0.100 | 0.100 | 0.100 | 0.100 | 0.100 |
| initiator | | | | | | | | | | | | | |
| Water-dispersible | TINUVIN 477 DW | — | 0.500 | — | — | — | — | — | — | — | — | — | — |
| organic | TINUVIN 479 DW | — | — | 0.500 | — | — | — | — | — | — | — | — | — |
| ultraviolet absorber | | | | | | | | | | | | | |
| Diluent | EtOH | 1.600 | 1.600 | 1.600 | 1.600 | 1.600 | 1.600 | 1.600 | 1.600 | 1.600 | 1.600 | 1.600 | 1.600 |
| | MIPA | 2.400 | 2.400 | 2.400 | 2.400 | 2.400 | 2.400 | 2.400 | 2.400 | 2.400 | 2.400 | 2.400 | 2.400 |
| | Distilled water | 1.198 | 1.198 | 1.198 | — | — | — | — | — | — | — | — | 0.661 |

### Example 1

Coating Agent 5 was coated to the easy adhesion-treated surface of the substrate COSMOSHINE A4100 using a #8 Meyer rod and dried at 60° C. in ambient atmosphere for 5 minutes. Then, the substrate to which the coating layer was applied was passed through an ultraviolet irradiator (H-valve (DRS model) from Fusion UV System Inc.) under a nitrogen atmosphere twice, and the coating layer was cured. At this time, the coating layer was irradiated with ultraviolet light (UV-A) in conditions of an illuminance of 700 mW/cm² and an integrated light quantity of 900 mJ/cm². A laminate including a coating layer having a thickness of 1.0 micrometer was thus produced.

### Example 2 to Example 6

Laminates of Example 2 to Example 6 were produced in the same manner as in Example 1 except for using coating agents shown in Table 3.

### Comparative Example 1

A substrate COSMOSHINE A4100 was used.

### Comparative Examples 2 to 7

Laminates of Comparative Examples 2 to 7 were produced in the same manner as in Example 1 except for using coating agents shown in Table 3. Here, Comparative Examples 3, 4, and 7 had high initial haze values and no transparency and thus were not evaluated for ultraviolet-shielding properties. Comparative Example 7 was not evaluated for hydrophilicity or adhesion either.

The evaluation results for Examples 1 to 6 and Comparative Examples 1 to 7 are shown in Table 3.

TABLE 3

| | | | Comp. | Comp. | Comp. | Comp. | Comp. | | | | | | | Comp. | Comp. |
|---|---|---|---|---|---|---|---|---|---|---|---|---|---|---|---|
| | | | Ex- | Ex- | Ex- | Ex- | Ex- | | | | | | | Ex- | Ex- |
| | | | ample | ample | ample | ample | ample | | | | | | | ample | ample |
| | | | 1 | 2 | 3 | 4 | 5 | Ex. 1 | Ex. 2 | Ex. 3 | Ex. 4 | Ex. 5 | Ex. 6 | 6 | 7 |
| Coating agent | | | — | 1 | 2 | 3 | 4 | 5 | 6 | 7 | 8 | 9 | 10 | 11 | 12 |
| Eval- | Trans- | Haze (%) | 0.65 | 0.41 | 31.86 | 50.72 | 0.33 | 1.12 | 1.36 | 1.97 | 2.53 | 2.77 | 2.94 | 5.67 | 34.48 |
| uation | parency | Light | 89.20 | 90.61 | 90.89 | 92.03 | 90.58 | 90.54 | 90.67 | 90.62 | 90.74 | 90.66 | 90.43 | 90.32 | 89.18 |
| item | | trans- | | | | | | | | | | | | | |
| | | mittance: | | | | | | | | | | | | | |
| | | TT (%) | | | | | | | | | | | | | |
| | | Diffuse | 0.58 | 0.37 | 28.96 | 46.67 | 0.30 | 1.02 | 1.23 | 1.79 | 2.29 | 2.51 | 2.66 | 5.12 | 30.75 |
| | | trans- | | | | | | | | | | | | | |
| | | mittance: | | | | | | | | | | | | | |
| | | DF (%) | | | | | | | | | | | | | |
| | | Parallel | 88.62 | 90.23 | 61.94 | 45.36 | 90.28 | 89.53 | 89.44 | 88.83 | 88.45 | 88.15 | 87.77 | 85.20 | 58.43 |
| | | light | | | | | | | | | | | | | |
| | | trans- | | | | | | | | | | | | | |
| | | mission: | | | | | | | | | | | | | |
| | | PT (%) | | | | | | | | | | | | | |
| | Ultra- | Light | 85.0 | 79.60 | Not | Not | 83.50 | 71.40 | 59.40 | 49.70 | 39.70 | 38.00 | 29.70 | 56.20 | Not |
| | violet- | trans- | | | measured | measured | | | | | | | | | measured |
| | shielding | mittance | | | | | | | | | | | | | |
| | properties | at 350 nm | | | | | | | | | | | | | |
| | | (%) | | | | | | | | | | | | | |
| | Hydro- | Water | 74.20 | 16.10 | 47.20 | 55.20 | 19.00 | 15.00 | 10.40 | 12.90 | 13.20 | 12.30 | 14.00 | 40.00 | Not |
| | philicity | contact | | | | | | | | | | | | | measured |
| | | angle | | | | | | | | | | | | | |
| | | (degrees) | | | | | | | | | | | | | |
| | Adhesion | | — | Good | Good | Good | Good | Good | Good | Good | Good | Good | Good | Good | Not |
| | | | | | | | | | | | | | | | measured |

### Example 7 to Example 11

Using the same coating agent 10 as in Example 6, the operation in Example 1 was repeated to overlay the coating layer, and a laminate having a 2- to 6-micrometer thick coating layer was each produced.

Each laminate was measured for light transmittance at 350 nm, and the results are illustrated in FIG. 1. As can be seen from FIG. 1, it was confirmed that the ultraviolet-shielding performance can also be adjusted by, for example, the film thickness of the coating layer, that is, the total amount of the ultraviolet-absorbing SiO₂-coated ZnO particles.

It will be apparent to those skilled in the art that various modifications can be made to the embodiments and the examples described above without departing from the basic principles of the present invention. In addition, it will be apparent to those skilled in the art that various improvements and modifications of the present invention can be carried out without departing from the spirit and the scope of the present invention.

1. A transparent hydrophilic ultraviolet-absorbing laminate comprising:
a substrate; and
a transparent hydrophilic ultraviolet-absorbing layer comprising first inorganic nanoparticles, second inorganic nanoparticles, and a hydrophilic binder, and exhibiting a water contact angle of 30.0 degrees or less;
wherein the first inorganic nanoparticles comprise at least one particle selected from silica, alumina, zirconium oxide, tin-doped indium oxide, and antimony-doped tin oxide; and
wherein the second inorganic nanoparticles are core-shell ultraviolet-absorbing particles different from the first inorganic nanoparticles, and the shell comprises silicon oxide.

2. The laminate according to claim 1, comprising a total of 70 mass % or greater of the first inorganic nanoparticles and the second inorganic nanoparticles based on the total weight of the transparent hydrophilic ultraviolet-absorbing layer.

3. The laminate according to claim 1, comprising the first inorganic nanoparticles in a proportion of 10 to 65 mass % based on the total weight of the transparent hydrophilic ultraviolet-absorbing layer.

4. The laminate according to claim 1, comprising the second inorganic nanoparticles in a proportion of 10 to 65 mass % based on the total weight of the transparent hydrophilic ultraviolet-absorbing layer.

5. The laminate according to claim 1, wherein an average particle size of the first inorganic nanoparticles is 15 nm or greater.

6. The laminate according to claim 1, wherein an average particle size of the second inorganic nanoparticles is greater than the average particle size of the first inorganic nanoparticles.

7. The laminate according to claim 1, wherein an average particle size of the second inorganic nanoparticles is from 50 to 400 nm.

8. The laminate according to claim 1, wherein the hydrophilic binder is at least one selected from polyethylene glycol, a resin comprising a hydroxyl group, and a (meth)acrylic resin comprising at least one selected from an amphoteric ion, ethylene oxide, and propylene oxide.

9. (canceled)

10. The laminate according to claim 1, wherein the core particle surfaces of the second inorganic nanoparticles are modified with L-lysine.

11. The laminate according to claim 1, wherein the core particles of the second inorganic nanoparticles comprise at least one particle selected from titanium oxide and zinc oxide.

12. The laminate according to claim 1, wherein the transparent hydrophilic ultraviolet-absorbing layer further comprises a first silane coupling agent.

13. The laminate according to claim 1, further comprising a primer layer containing third inorganic nanoparticles and a second silane coupling agent between the substrate and the transparent hydrophilic ultraviolet-absorbing layer.

14. The laminate according to claim 13, wherein the content of the third inorganic nanoparticles in the primer layer is less than the total content of the first inorganic nanoparticles and the second inorganic nanoparticles in the transparent hydrophilic ultraviolet-absorbing layer.

15. The laminate according to claim 13, wherein the third inorganic nanoparticles comprise at least one particle selected from silica, alumina, zirconium oxide, tin-doped indium oxide, and antimony-doped tin oxide.

16. The laminate according to claim 1, wherein a light transmittance at wavelength from 400 to 700 nm is 85.0% or higher, and a haze is 5.0% or lower.

17. The laminate according to claim 1, wherein a light transmittance at a wavelength of 350 nm is 75.0% or lower.

18. A transparent hydrophilic ultraviolet-absorbing coating agent containing first inorganic nanoparticles, second inorganic nanoparticles, and at least one selected from a hydrophilic binder, a hydrophilic curable monomer, and a hydrophilic curable oligomer,
wherein the first inorganic nanoparticles comprise at least one particle selected from silica, alumina, zirconium oxide, tin-doped indium oxide, and antimony-doped tin oxide;
wherein the second inorganic nanoparticles are core-shell ultraviolet-absorbing particles different from the first inorganic nanoparticles, and the shell comprises silicon oxide; and
a transparent hydrophilic ultraviolet-absorbing layer formed by the coating agent exhibits a water contact angle of 30.0 degrees or less.
